(19) United States
(12) Patent Application Publication
(10) Pub. No.: US 2009/0109149 A1
(43) Pub. Date: Apr. 30, 2009

(54) Image display device

(75) Inventors: Hajime Akimoto, Kokubunji (JP); Norihiro Nakamura, Mobara (JP); Yasuharu Yatsu, Chiba (JP); Hiroshi Kageyama, Hachioji (JP); Tohru Kohno, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/289,669

(22) Filed: Oct. 31, 2008

(30) Foreign Application Priority Data
Oct. 31, 2007 (JP) 2007-282639

(51) Int. Cl. G09G 3/30

(52) U.S. Cl. 345/76

(57) ABSTRACT

An image display device having a plurality of pixel, a plurality of signal lines for inputting an image voltage to each of the plurality of pixels, and a pixel selecting unit for selecting from the plurality of pixels a pixel into which the image voltage is to be written, in which each of the pixels has a light emitting device of a current driving-type, a driving transistor connected between a power line and the light emitting device, and a capacitance device having one end connected to a gate electrode of the driving transistor, the image voltage is input to the other end of the capacitance device during the writing period, an inclined wave voltage which changes a voltage level thereof according to time is input to the other end of the capacitance device during a light emission period following the writing period.

### CROSS-REFERENCE TO RELATED APPLICATION

The present application claims priority from Japanese application JP2007-282639 filed on Oct. 31, 2007, the content of which is hereby incorporated by reference into this application.

### BACKGROUND OF THE INVENTION

1. Field of the Invention

The present invention relates to an image display device, and in particular to an organic electro-luminescence display employing an active matrix method.

2. Description of the Related Art

An active matrix-driven organic electro-luminescence (Electro Luminescence) display (hereinafter referred to as an organic EL display device) is expected as a next generation flat panel display.

Conventionally, as a driving circuit of an organic EL display device, there is known a circuit having a circuit structure comprising a driving thin film transistor (hereinafter referred to as a drive TFT) for supplying driving current to an organic electro-luminescence device (hereinafter referred to as an organic EL device), a holding capacitor having one end connected to the gate electrode of the drive TFT, for holding an image voltage, a reset thin film transistor (hereinafter referred to as a reset switch) connected between the gate electrode and drain electrode of the drive TFT, a thin film transistor (hereinafter referred to as a pixel switch) for connecting the other end of the holding capacitor to a signal line, and a thin film transistor (hereinafter referred to as a triangle wave switch) for connecting the other end of the holding capacitor to a triangle wave voltage input line. The above-described structure is disclosed in Japanese Patent Laid-open Publication No. 2003-005709.

FIG. 6A is a circuit structural diagram for explaining a structure of a pixel of a conventional organic EL display panel. Note that the circuit structure is disclosed also in Japanese Patent Laid-open Publication No. 2003-005709.

As shown in FIG. 6A, each pixel 201 has an organic EL device 202 having one end connected to a common electrode 203 and being connected to a power line (PWR) via the drive TFT (Thin Film-Transistor) 204. A reset switch 205 is connected between the gate electrode and drain electrode of the drive TFT 204.

Also, the gage electrode of the drive TFT 204 is connected to one end of the holding capacitor 206, of which other end is connected to a pixel switch 207 connected to a signal line (DAT) and also to a triangle wave switch 208 connected to a triangle wave line (SWP). Note that the reset switch 205 is controlled via the reset switch control line 211; the pixel switch 207 is controlled via the pixel switch control line 209; and the triangle wave switch 208 is controlled via the triangle wave switch control line 210.

In the following, operation of a conventional example will be described.

FIG. 6B is a diagram showing voltage levels of the pixel switch control line 209, triangle wave switch control line 210, and reset switch control line 211, these shown in FIG. 6A. The denotations ON, OFF given for the pixel switch control line 209 refer to the ON and OFF states, respectively, of the pixel switch 207. Similarly, the denotations ON, OFF given for the triangle wave switch control line 210 refer to the ON and OFF states of the triangle wave switch 208, respectively, and those for the reset switch control line 211 refer to the ON and OFF states of the reset switch 205, respectively.

In a pixel selected for writing, during the writing period from time t0 to t2, the voltage of the pixel switch control line 209 remains at the high level (hereinafter referred to as an H level) and the pixel switch 207 remains in the ON state. During the first period from time t0 to time t1, the voltage of the reset switch control line 211 remains at the H level and the reset switch 205 remains in the ON state. Note that during the writing period from time t0 to time t2, since the triangle wave switch control line 210 remains at the low level (hereinafter referred to as an L level), the triangle wave switch 208 remains in the OFF state.

During the first period, current flows into the organic EL device 202 from the power line (PWR) via the drive TFT 204 in diode connection. Note that the drive TFT 204 and organic EL device 202 together constitute an inverter circuit having an input which is the gate electrode of the drive TFT 204 and an output which is the point where the drive TFT 204 is connected to the organic EL device 202. During the first period, the input and output of the inverter circuit are short-circuited by the reset switch 205.

During the first period, an input middle point voltage for inverting the inverter is generated at the input/output of the inverter circuit, and the generated input middle point voltage is input to one end of the holding capacitor 206. Further, during the first period, a signal voltage applied to the signal line (DAT) is input to the other end of the holding capacitor 206 via the pixel switch 207.

Thereafter, during the second period from time t1 to time t2, with the voltage of the reset switch control line 211 dropping to the L level, the reset switch 205 remains in the OFF state, so that the difference voltage between the above described input middle point voltage and the signal voltage is stored in the holding capacitor 206. With the above, writing operation is completed.

Thereafter, at time t2, with writing shifted to a pixel in the next row, the voltage of the pixel switch control line 209 drops to the L level, and the pixel switch 207 is thus switched to the OFF state, and simultaneously, the voltage of the triangle wave switch control line 210 rises to the H level, and the triangle wave switch 208 is thus turned to be in the ON state.

Consequently, a triangle wave-like sweep voltage (a triangle wave voltage) is applied to the other end of the holding capacitor 206 from the triangle wave line (SWP).

The triangle wave voltage is a voltage generally containing a signal voltage. When the triangle wave voltage is equal to the signal voltage written beforehand, previous input middle point voltage is reproduced in the gate electrode of the drive TFT 204 by the action of the holding capacitor 206. That is, depending on the relative magnitude between the triangle wave voltage and written signal voltage, ON/OFF of the inverter circuit having an output which is the middle point between the drive TFT 204 and organic EL device 202 can be controlled in terms of time.

With the inverter circuit in the ON state, obviously, the organic EL device 202 remains lit, and with the inverter circuit in the OFF state, the organic EL device 202 remains not lit. Therefore, it is possible to control the lighting period of each pixel within one frame period by controlling a signal voltage with respect to a predetermined triangle wave voltage, and to thereby display an image on an organic EL display panel.

### SUMMARY OF THE INVENTION

As to the pixel shown in FIG. 6A, actually, a plurality of pixels are arranged in a matrix. Assuming that the number of pixels is 320 (horizontal)×RGB×240 (vertical), 240 organic EL devices 202 are connected to a single power line (PWR) shown in FIG. 6A.

Then, because the power line (PWR) has some resistant component, the voltage level of the power line (PWR) will change according to the number of the organic EL device 202 being lit. Also, the voltage level of the power line (PWR) will change due to noise.

Meanwhile, in the circuit shown in FIG. 6A, the drive TFT 204 operates in the linear region (Lre) shown in FIG. 8. That is, the drive TFT 204 shown in FIG. 6A operates as an ON/OFF switch. Therefore, when the drive TFT 204 shown in FIG. 6A is in the ON state, a power supply voltage of the power line (PWR) is applied to the anode electrode of the organic EL device 202. Note that FIG. 8 is a schematic diagram for describing voltage (V_{D})-current (I_{D}) characteristic of a thin film transistor, in which Lre refers to a linear region and Sre refers to a saturation region.

That is, in a conventional organic EL display device, because the organic EL device 202 is usually driven by two values, namely, ON/OFF, change of the voltage level of the power line (PWR) due to noise or resistant component and the like of its own power line (PWR) may affect the organic EL device 202.

FIG. 7 is a schematic diagram for describing voltage (V_{D})-current (I_{D}) characteristic of an organic EL device (an organic light emitting diode device). FIG. 7A shows voltage-current characteristic of an organic EL device with moderate rise of diode characteristic, while FIG. 7B shows voltage-current characteristic of an organic EL device with sharp rise of diode characteristic.

As shown in FIG. 7, the organic EL device presents diode characteristic. Therefore, change of the voltage level of the power line (PWR) causes the current flowing through the organic EL device 202 to change, which also causes the light emission brightness of the organic EL device 202 to change.

As shown in FIG. 7, suppose that current (Io) flows through the organic EL device in a steady state. In this case, when the power supply voltage changes by (±ΔV), current changes by (±ΔIa) in an organic EL device having the diode characteristic shown in FIG. 7A, and by (±ΔIb) in an organic EL device having the diode characteristic shown in FIG. 7B.

Further, as readily known from FIG. 7, the current flowing in the organic EL device having the diode characteristic shown in FIG. 7B changes more largely than that flowing in the organic EL device having the diode characteristic shown in FIG. 7A.

Still further, while an organic EL device having the diode characteristic shown in FIG. 7A has been conventionally common, an organic EL device having the diode characteristic shown in FIG. 7B recently comes to be used. In a conventional organic EL display device, change of the voltage level of the above described power line (PWR) causes the current flowing through the organic EL device 202 to change largely, which also causes the light emission brightness of the organic EL device 202 to change largely.

As described above, a conventional organic EL display device has a problem that change of the voltage level of the power line (PWR) causes the current flowing through the organic EL device 202 to change, which further causes the light emission brightness of the organic EL device 202 to change.

The present invention has been conceived to solve the above described problem of conventional art, and aims to provide technique for reducing change of the light emission brightness of a light emitting device due to change of the voltage level of the power supply voltage in an image display device.

The above described and other objects and new characteristics of the present invention will become obvious from the following description and the accompanying drawings.

A representative invention among those described in this specification can be described briefly as follows.

According to one aspect of the present invention, there is provided an image display device having a plurality of pixels, into each of which an image voltage is input during a writing period and an inclined wave voltage which changes a voltage level thereof according to time is input during a light emission period following the writing period, wherein each of the pixels has light emitting means, a driving transistor for driving the light emitting means, and a capacitance device having one end connected to a gate electrode of the driving transistor, the image voltage and the inclined wave voltage are input to other end of the capacitance device during the writing period and the light emission period, respectively, and light emission intensity of the light emitting means while emitting light always changes within the light emission period.

Also, according to another aspect of the present invention, there is provided an image display device, having a plurality of pixels, a plurality of signal lines for inputting an image voltage to each of the plurality of pixels, and pixel selecting means for selecting from the plurality of pixels a pixel into which the image voltage is to be written via the plurality of signal lines, wherein each of the pixels has a light emitting device of a current driving-type, a driving transistor connected between a power line and the light emitting device, and a capacitance device having one end connected to a gate electrode of the driving transistor, the image voltage is input to other end of the capacitance device during the writing period, inclined wave voltage which changes a voltage level thereof according to time is input to the other end of the capacitance device during a light emission period following the writing period, and light emission intensity of the light emitting device while emitting light always changes within the light emission period.

Also, in one embodiment of the present invention, the pixel selecting means may have a plurality of scanning lines, each of the pixels may have a reset transistor connected between the gate electrode of the driving transistor and an electrode of the driving transistor, the electrode being connected to the light emitting device, and the gate electrode of the reset transistor may be connected to a corresponding scanning line among the plurality of scanning lines.

Also, in another embodiment of the present invention, the pixel selecting means may have a plurality of lighting control lines, each of the pixels may have a lighting transistor connected between the driving transistor and the light emitting device, a gate electrode of each lighting transistor may be connected to a corresponding lighting control line among the plurality of lighting control lines.

Also, in a still another embodiment of the present invention, the writing period may be divided into successive first to third periods, the reset transistor of each of the pixels may remain on during the first period and the second period within the writing period and off during the third period within the writing period and the light emission period, the lighting transistor of each of the pixels may remain on during the light emission period and the first period within the writing period and off during the second period and the third period within the writing period.

Also, in a yet another embodiment of the present invention, the image display device may further comprise a plurality of inclined wave voltage input lines for inputting the inclined wave voltage to each of the pixels, wherein each of the pixels may include a first switching transistor for connecting the other end of the capacitance device to a corresponding signal line among the plurality of signal lines during the writing period, and a second switching transistor for connecting the other end of the capacitance device to a corresponding inclined wave voltage input line among the plurality of inclined wave voltage input lines during the light emission period.

Also, in a yet another embodiment of the present invention, the pixel selecting means may include a plurality of switch control lines, the first switching transistor and the second switching transistor may differ from each other in an electricity conductive type, a gate electrode of the first switching transistor of each of the pixels and a gate electrode of the second switching transistor may be connected to a corresponding same switch control line among the plurality of switch control lines, the first switching transistor of each of the pixels may remain on and the second switching transistor remains off during the writing period, and the first switching transistor of each of the pixels may remain off and the second switching transistor remains on during the light emission period.

Also, in a yet another embodiment of the present invention, the light emitting device may be an organic light emitting diode device.

Advantage obtained by the representative invention among those described in this specification can be described briefly as follows.

According to an image display device according to the present invention, it is possible to reduce change of the light emission brightness of the light emitting device due to change of the voltage level of the power supply voltage.

### BRIEF DESCRIPTION OF THE DRAWINGS

FIG. 1 is a block diagram showing a schematic structure of an organic EL display panel of an image display device according to an embodiment of the present invention;

FIG. 2 is a circuit structural diagram for explaining a structure of the pixel shown in FIG. 1;

FIG. 3 is a timing chart for explaining operation of pixels in the n^{th} and (n+1)^{th} rows in the organic EL display panel according to the embodiment of the present invention;

FIG. 4 is an operation timing chart for writing an image voltage into a pixel in the organic EL display panel according to the embodiment of the present invention;

FIG. 5 is a diagram showing in detail a state of light emission of the organic EL display panel according to the embodiment of the present invention;

FIG. 6A is a circuit structural diagram for explaining a structure of a pixel in a conventional organic EL display panel;

FIG. 6B is a diagram showing voltage levels of a pixel switch control line, a triangle wave switch control line, and a reset switch control line shown in FIG. 6A;

FIG. 7 is a schematic view for describing voltage (V_{D})-current (I_{D}) characteristic of an organic light emitting diode device; and

FIG. 8 is a schematic view for describing voltage (V_{D})-current (I_{D}) characteristic of a thin film transistor.

### DETAILED DESCRIPTION OF THE INVENTION

In the following, an embodiment of the present invention will be described in detail with reference to the drawings.

Note that elements having identical function in all drawings for explaining the embodiment will be given the same reference number with description thereof not repeated.

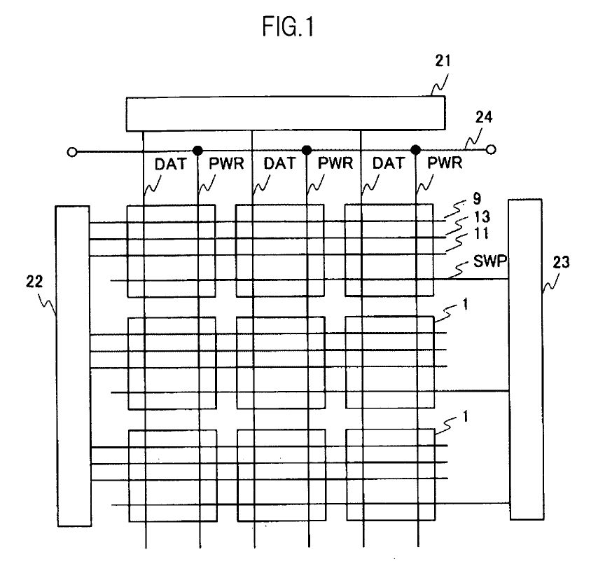

FIG. 1 is a block diagram showing a schematic structure of an organic EL display panel of an image display device according to the present invention, and specifically a diagram showing a schematic structure of an organic EL display panel for use with a portable phone.

As shown in FIG. 1, pixels 1 are arranged in a matrix in the display area of the organic EL display panel, in which each pixel 1 is connected to a signal line (DAT) in the vertical direction, a pixel switch control line 9, a lighting control switch control line 13, and a reset switch control line 11 in the horizontal direction. One end of the signal line (DAT) is connected to an image voltage production circuit 21. Also, one ends of the pixel switch control line 9, lighting control switch control line 13, and reset switch control line 11 are connected to a scanning circuit 22.

Also, each pixel 1 is connected to a power line (PWR) in the vertical direction. The power line (PWR) is connected at the upper end thereof to a main power line 24 to output to the connection terminals provided on the left and right sides of the panel. Further, each pixel 1 is connected to a triangle wave line (SWP) in the horizontal direction. One end of the triangle wave line (SWP) is connected to a triangle wave production circuit 23.

Note that for brevity of the drawings, only nine pixels are shown in FIG. 1, though in actuality, the number of pixels, being, e.g., 320 (horizontal)×RGB×240 (vertical), are provided. Also, the pixels in the display area, the scanning circuit 22, and the triangle wave production circuit 23 are formed using thin film transistors (Si-TFT) having a semiconductor layer made of poly-crystalline silicon formed on the same glass substrate, and the image voltage production circuit 21 is provided by mounting a driver IC chip on the glass substrate.

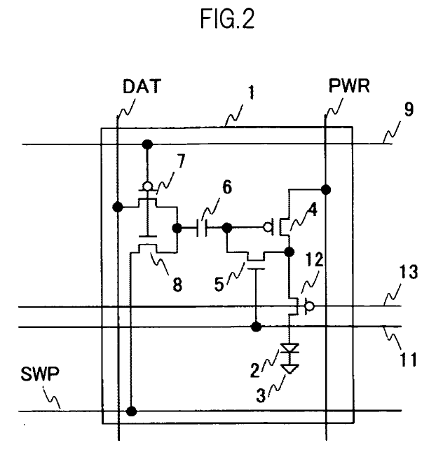

In the following, a structure of the pixel 1 shown in FIG. 1 will be described. FIG. 2 is a circuit structural diagram for explaining a structure of the pixel 1 shown in FIG. 1.

Each pixel 1 has an organic electro-luminescence device 2 of a bottom emission type (hereinafter referred to as an organic EL device) having a cathode electrode connected to a common electrode 3 and an anode electrode connected to the power line (PWR) via a p-type thin film transistor (hereinafter referred to as a lighting control switch) 12 and a p-type thin film transistor (hereinafter referred to as a drive TFT) 4.

An n-type thin film transistor (hereinafter referred to as a reset switch 5) is connected between the gate and drain electrodes of the drive TFT 4.

Also, the gate electrode of the drive TFT 4 is connected to one end of a holding capacitor (a capacitance device according to the present invention) 6, of which other end is connected via a p-type thin film transistor (hereinafter referred to as a pixel switch) 7 to the signal line (DAT), and via an n-type thin film transistor (hereinafter referred to as a triangle wave switch) 8 to the triangle wave line (SWP).

Note that the reset switch 5 is controlled via the reset switch control line 11; the lighting control switch 12 is controlled via the lighting control switch control line 13; and the pixel switch 7 and triangle wave switch 8 are controlled via the pixel switch control line 9.

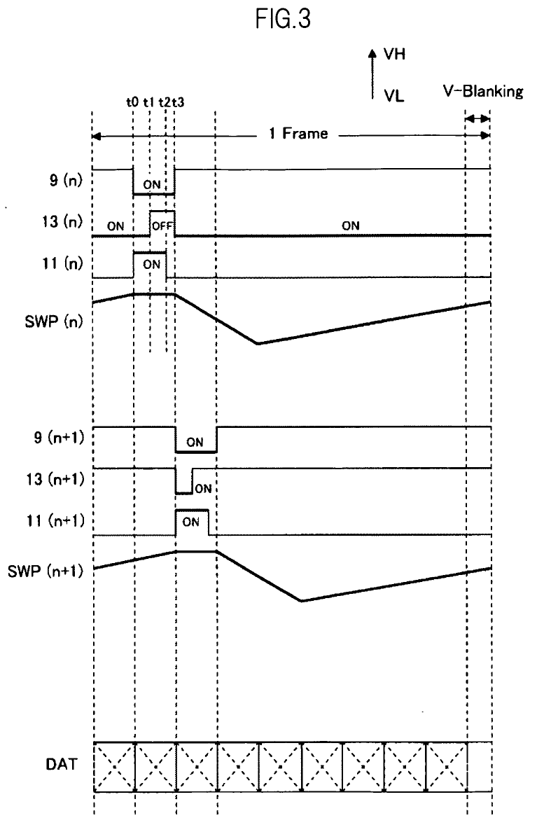

In the following, operation of an image display device according to this embodiment will be described with reference to FIGS. 3 to FIG. 5.

FIG. 3 is a timing chart for describing operation of pixels 1 in the n^{th} and (n+1)^{th} rows in the organic EL display panel according to this embodiment.

FIG. 3 shows change of the voltage level within one frame (Frame) period, of the pixel switch control line 9, lighting control switch control line 13, reset switch control line 11, and triangle wave line (SWP), in which (n) refers to a signal for the n^{th} pixel row. Also, as denoted as VH, VL in the diagram, the upper side of the diagram corresponds to a higher voltage, while lower side of the same corresponds to a lower voltage.

Further, the denotations ON, OFF given for the pixel switch control line 9 refer to the ON and OFF states, respectively, of the pixel switch 7. Similarly, the denotations ON, OFF for the lighting control switch control line 13 refer to the ON and OFF states of the light emission control switch 12, respectively, and those for the reset switch control line 11 refer to the ON and OFF states of the reset switch 5. Note that because the pixel switch 7 and triangle wave switch 8 are formed using thin film transistors of different electricity conductivity types, the triangle wave switch 8 remains in the OFF state when the pixel switch 7 remains in the ON state, and the triangle wave switch 8 remains in the ON state when the pixel switch 7 remains in the OFF state.

For the pixel 1 (a pixel in the n^{th} display line here) 1 selected for writing, initially at time t0, since the pixel switch control line 9 remains at the low level (hereinafter referred to as an L level), the lighting control switch control line 13 remains at the L level, and the reset switch control line 11 remains at the high level (hereinafter referred to as an H level), the pixel switch 7 remains in the ON state, the triangle wave switch 8 remains in the OFF state, the lighting control switch 12 remains in the ON state, and the reset switch 5 remains in the ON state.

In this state, with the lighting control switch 12 and reset switch 5 remaining in the ON state, current flows into the organic EL device 2 from the power line (PWR) via the drive TFT 4 and lighting control switch 12 in diode connection.

Subsequently, at time t1, once the lighting control switch control line 13 becomes H level and the lighting control switch 12 comes to be in the OFF state, the drive TFT 4 is turned off (OFF state) in response to the drain electrode of the drive TFT 4 having become equal to the threshold voltage (Vth).

In this state, an image voltage is input to the signal line (DAT). Then, since the signal line (DAT) is input to one end of the holding capacitor 6 via the pixel switch 7, the difference between the image voltage and a threshold voltage (Vth) is held in the holding capacitor 6.

Thereafter, at time t2, once the reset switch control line 11 becomes L level and the reset switch 5 comes to be in the OFF state, the difference between the image voltage and threshold voltage (Vth) is held in the holding capacitor 6, upon which writing of the image voltage into the pixel 1 is completed.

Thereafter, at time t3, once writing shifts to the pixel 1 in the (n+1)^{th} display line, the pixel switch control line 9 becomes H level, the pixel switch 7 is switched to the OFF state, and the triangle wave switch 8 is switched to the ON state.

Here, a triangle wave-shaped sweep voltage is applied to the triangle wave line (SWP), and the triangle wave voltage is input via the triangle wave switch 8 to one end of the holding capacitor 6. Also, in this state, since the lighting control switch control line 13 remains at the L level, the lighting control switch 12 remains in the ON state.

Since the threshold voltage (Vth) is reproduced in the gate of the drive TFT 4 via the holding capacitor 6 when the triangle wave voltage of the triangle wave line (SWP) is equal to the image voltage written beforehand, the light emission period for the organic EL device 2 is determined according to the image voltage written beforehand. With the above, because the organic EL device 2 emits light during a light emission period corresponding to the image voltage with light emission intensity corresponding to the image voltage, an observer recognizes an image having gradation.

It should be noted that, although a triangle wave voltage is applied during the light emission period in this embodiment, an inclined wave voltage, such as, e.g., a stepping wave voltage, a saw tooth wave voltage, and so forth, which changes the voltage level thereof according to time may be applicable as a voltage to be applied during the light emission period.

Here, change of the gate voltage of the drive TFT 4 when writing will be described in detail.

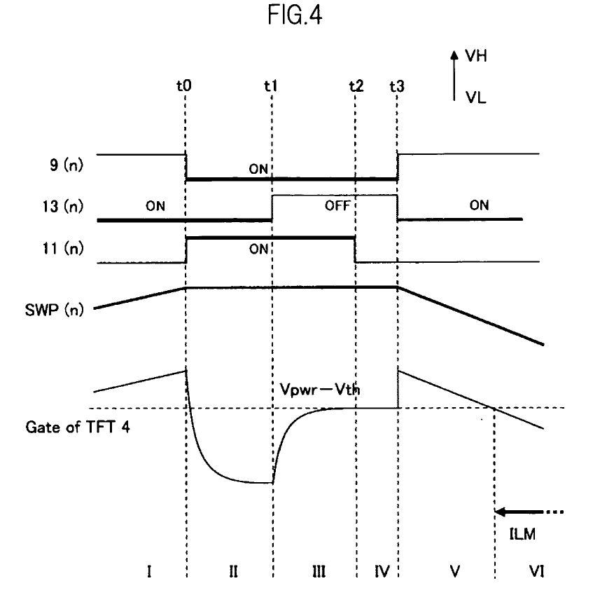

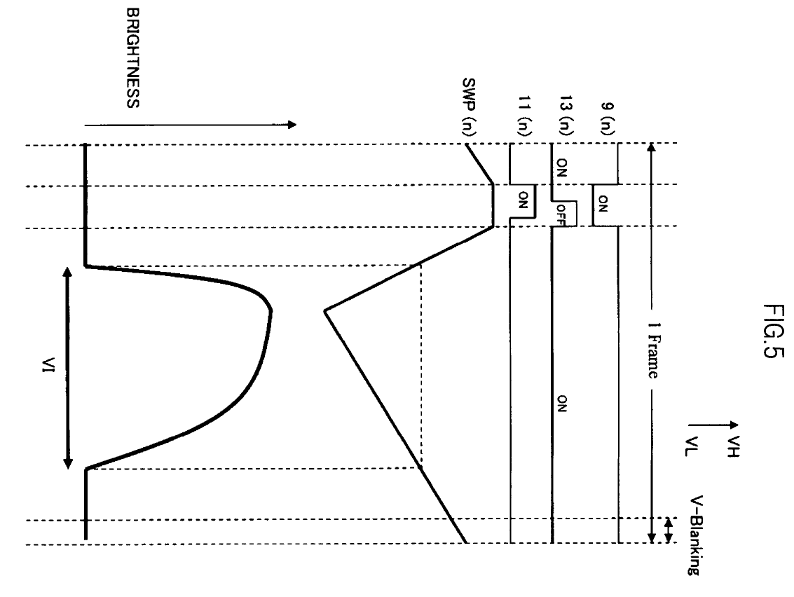

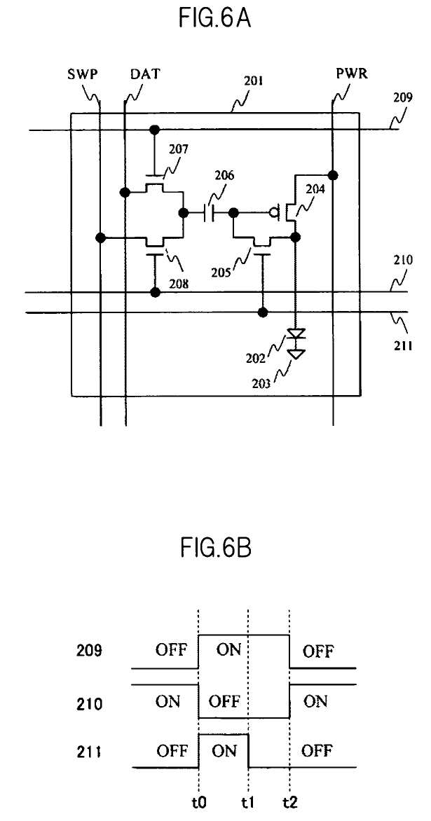

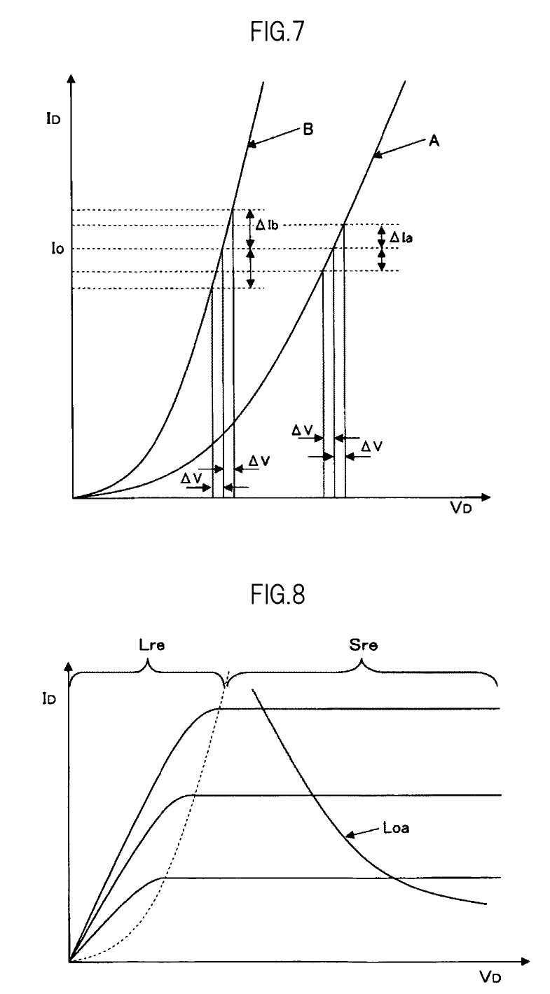

FIG. 4 is an operation timing chart for writing an image voltage into a pixel in the organic EL display panel according to this embodiment. FIG. 4 shows change within one frame period, of the pixel switch control line 9, lighting control switch control line 13, reset switch control line 11, and triangle wave line (SWP), in which (n) refers to a signal for the n^{th} pixel row.

Also, as denoted as VH, VL in the diagram, the upper side of the diagram corresponds to a higher voltage, while the lower side thereof corresponds to a lower voltage. These definitions are the same as those for FIG. 3.

FIG. 4 shows as a gate of TFT 4, change of the gate voltage of the drive TFT 4 when writing.

With the pixel 1 selected for writing, initially at time t0, the lighting control switch 12 and reset switch 5 come to be in the ON state, upon which current flows from the power line (PWR) to the organic EL device 2 via the drive TFT 4 in diode connection and lighting control switch 12. In the above, the gate voltage of the drive TFT 4 drops to a gate voltage compatible with the current of the organic EL device 2. (Period II)

Thereafter, at time t1, once the lighting control switch 12 comes to be in the OFF state, the drain electrode of the drive TFT 4 comes to be saturated toward the voltage value obtained by subtracting the threshold voltage (Vth) from the voltage (Vpwr) of the power line (PWR), and the drive TFT 4 is then turned off, that is, comes to be in the OFF state. (Period III)

Thereafter, at time t2, once the reset switch 5 comes to be in the OFF state, the difference between the image voltage and threshold voltage (Vth) is held in the holding capacitor 6, upon which writing of the image voltage into the pixel 1 is completed. (Period IV)

Thereafter, at time t3, once writing shifts to the pixel 1 in the next row, the pixel switch 7 is switched to the OFF state, and the triangle wave switch 8 is switched to the ON state. A triangle wave-shaped sweep voltage is applied to the triangle wave line (SWP), and the triangle wave voltage is input to one end of the holding capacitor 6 via the triangle wave switch 8.

In the above, the gate voltage of the drive TFT 4 shifts according to the difference between the voltage applied to the triangle wave line (SWP) and the image voltage written beforehand. When the triangle wave voltage of the triangle wave line (SWP) is equal to the image voltage written beforehand, the threshold voltage (Vth) is reproduced at the gate electrode of the drive TFT 4 via the holding capacitor 6, and the organic EL device 2 is thus turned on. (Period VI)

The light emission period of the organic EL device 2 is denoted as an ILM period in FIG. 4. By modifying the length of the ILM period by utilizing the image voltage to be written into each pixel, it is possible to display an image on the organic EL display panel.

FIG. 5 is a diagram showing in detail a state of light emission on the organic EL display panel according to this embodiment. Here, change of the triangle wave voltage in the triangle wave line (SWP) and that of the light emission intensity of the organic EL device 2 in synchronism with the triangle wave voltage are shown in accordance with timing concerning the respective signals described referring to FIG. 3, the latter being denoted as BRIGHTNESS.

As shown in FIG. 5, in this embodiment, although the organic EL device 2 is turned on during the period VI in FIG. 4, the light emission intensity thereof follows the change of the triangle wave voltage in the triangle wave line (SWP), and the brightness will not be saturated. This is because the drive TFT 4 is driven in the saturation region (Sre) shown in FIG. 8.

When the thin film transistor operates in the saturation region (Sre) shown in FIG. 8, the drain voltage (Vd) and drain current (Id) of the thin film transistor come to be equal to the drain voltage (Vd) and drain current (Id), respectively, on the load curve (Loa), shown in FIG. 8.

Therefore, in this embodiment, compared to a case, such as with a conventional organic EL display panel, in which the drive TFT is driven in a linear region (Lre), it is possible to arrange such that the current flowing in the organic EL device 2 will change less. That is, in this embodiment, since the light emission intensity of the organic EL device 2 is basically controlled via the triangle wave voltage of the triangle wave line (SWP), it is possible to reduce change of the light emission intensity of the EL device 2 relative to change of the voltage level of the power line (PWR).

As described above, while change of the voltage level of the power line (PWR) affects to directly modify the power supply voltage of the organic EL device 2 in a conventional organic EL display panel, change of the voltage level of the power line (PWR) modifies only the source-drain voltage of the drive TFT 4 in this embodiment.

It should be noted that, in the above-described embodiment, the pixels 1 in the display area, the scanning circuit 22, and the triangle wave production circuit 23 are formed using polycrystalline Si-TFT devices formed on the same glass substrate, and the image voltage production circuit 21 is formed by mounting the driver IC chip on the glass substrate.

However, the scanning circuit 22 and triangle wave production circuit 23 can be realized using the same or different drive IC chip as or from that which is used for the image voltage production circuit 21. Also, the drive TFT 4, reset switch 5, pixel switch 7, triangle wave switch 8, and lighting control switch 12 may be formed on a glass substrate, each using an amorphous silicon thin film transistor having a semiconductor layer made of amorphous silicon.

Also, alternatively, the image voltage production circuit 21 can be formed using a polycrystalline Si-TFT device. Also, the image voltage production circuit 21 can be realized using combination of a driver IC chip mounted on a glass substrate and a selector switch or scanning circuit formed using a polycrystalline Si-TFT formed on a glass substrate.

Also, use of an organic/inorganic semiconductor thin film other than one using polycrystalline silicon, rather than limiting to polycrystalline silicon, for a transistor and/or use of a substrate, other than a glass substrate, with the surface thereof insulated is applicable.

Further, obviously, a general light emitting device such as an inorganic EL device and/or FED (Field-Emission Device) can be used, rather than limiting to an organic EL device, as a light emitting device.

An invention achieved by the present invention has been specifically described based on the above described embodiment. However, the present invention is not limited to the above described embodiment, and rather is adapted to various modifications within a range not departing from the gist of the present invention.

What is claimed is:

1. An image display device having a plurality of pixels, into each of which an image voltage is input during a writing period and an inclined wave voltage which changes a voltage level thereof according to time is input during a light emission period following the writing period, wherein
each of the pixels has
light emitting means,
a driving transistor for driving the light emitting means, and
a capacitance device having one end connected to a gate electrode of the driving transistor,
the image voltage and the inclined wave voltage are input to other end of the capacitance device during the writing period and the light emission period, respectively, and
light emission intensity of the light emitting means while emitting light always changes within the light emission period.

2. An image display device, having
a plurality of pixels,
a plurality of signal lines for inputting an image voltage to each of the plurality of pixels, and
pixel selecting means for selecting from the plurality of pixels a pixel into which the image voltage is to be written via the plurality of signal lines,
wherein
each of the pixels has
a light emitting device of a current driving-type,
a driving transistor connected between a power line and the light emitting device, and
a capacitance device having one end connected to a gate electrode of the driving transistor,
the image voltage is input to other end of the capacitance device during the writing period,
inclined wave voltage which changes a voltage level thereof according to time is input to the other end of the capacitance device during a light emission period following the writing period, and
light emission intensity of the light emitting device while emitting light always changes within the light emission period.

3. The image display device according to claim 2, wherein
the pixel selecting means has a plurality of scanning lines,
each of the pixels has a reset transistor connected between the gate electrode of the driving transistor and an electrode of the driving transistor, the electrode being connected to the light emitting device, and
the gate electrode of the reset transistor is connected to a corresponding scanning line among the plurality of scanning lines.

4. The image display device according to claim 2, wherein
the pixel selecting means has a plurality of lighting control lines,
each of the pixels has a lighting transistor connected between the driving transistor and the light emitting device,
a gate electrode of each lighting transistor is connected to a corresponding lighting control line among the plurality of lighting control lines.

5. The image display device according to claim 4, wherein
the writing period is divided into successive first to third periods,
the reset transistor of each of the pixels remains on during the first period and the second period within the writing period and off during the third period within the writing period and the light emission period,
the lighting transistor of each of the pixels remains on during the light emission period and the first period within the writing period and off during the second period and the third period within the writing period.

6. The image display device according to claim 2, further comprising
a plurality of inclined wave voltage input lines for inputting the inclined wave voltage to each of the pixels,
wherein
each of the pixels includes
a first switching transistor for connecting the other end of the capacitance device to a corresponding signal line among the plurality of signal lines during the writing period, and
a second switching transistor for connecting the other end of the capacitance device to a corresponding inclined wave voltage input line among the plurality of inclined wave voltage input lines during the light emission period.

7. The image display device according to claim 6, wherein
the pixel selecting means includes a plurality of switch control lines,
the first switching transistor and the second switching transistor differ from each other in an electricity conductive type,
a gate electrode of the first switching transistor of each of the pixels and a gate electrode of the second switching transistor are connected to a corresponding same switch control line among the plurality of switch control lines,
the first switching transistor and the second switching transistor of each of the pixels remain on and off, respectively, during the writing period, and
the first switching transistor and the second switching transistor of each of the pixels remain off and on, respectively, during the light emission period.

8. The image display device according to claim 1 wherein the light emitting device is an organic light emitting diode device.

9. The image display device according to claim 2 wherein the light emitting device is an organic light emitting diode device.
